(19) United States
(12) Patent Application Publication
(10) Pub. No.: US 2012/0250149 A1
(43) Pub. Date: Oct. 4, 2012

(54) Ultrahigh-Wavenumber Transmitting Element and Near-Field Optical Microscope Using Thereof

(76) Inventors: Koichi Karaki, Tokyo (JP); Yasuo Sasaki, Tokyo (JP); Takuya Tsukagoshi, Tokyo (JP); Yoshiharu Ajiki, Tokyo (JP); Isao Shimoyama, Tokyo (JP); Kiyoshi Matsumoto, Tokyo (JP); Tetsuo Kan, Tokyo (JP); Yusuke Takei, Tokyo (JP); Kentaro Noda, Tokyo (JP)

(21) Appl. No.: 13/435,365

(22) Filed: Mar. 30, 2012

(30) Foreign Application Priority Data
Mar. 30, 2011 (JP) 2011-076892

(51) Int. Cl. G02B 21/06

(52) U.S. Cl. 359/385

(57) ABSTRACT

An ultrahigh-wavenumber transmitting element has at least two anisotropic media having slopes of isofrequency curves complementary with each other. The at least two anisotropic media are layered so as to transmit ultrahigh wavenumber.

### CROSS REFERENCE TO RELATED APPLICATION

The present application claims priority to Japanese Patent Application No. 2011-076892 filed on Mar. 30, 2011, the entire disclosure of which is fully incorporated herein by reference.

### BACKGROUND OF THE INVENTION

The present invention relates to an ultrahigh-wavenumber transmitting element and near-field optical microscope using thereof.

### RELATED ART

Sub-wavelength imaging can be performed by employing a structure of layered indefinite media (see, for example, US2009/0273538 A1). Here, sub-wavelength imaging is a technology of transmitting more minute optical information relative to a wavelength of a light used for imaging from an object plane to an imaging plane. In a conventional optical system, such as optical microscope and an optical recording system, optical information smaller than a wavelength can not be transmitted farther than a distance as far as the wavelength due to their diffraction limit. Thanks to the advancement of near field optics, more minute optical information relative to a wavelength is beginning to be handled. However, such technology is not free from a constraint caused by the diffraction limit and a possible distance for transmitting optical information is still limited within a distance as long as its wavelength.

On the other hand, the diffraction limit can be overcome essentially by employing media (super lens) having a negative effective refraction index by utilizing metamaterial and so on (see, for example, J. B. Pendry, Physical Review Letters, Vol. 85, p. 3966-3969 (2000)). The indefinite media disclosed in US2009/0273538 A1 can be perceived as an advanced super lens. Both permittivity and permeability need to be adjusted to predetermined value to provide the indefinite media. On the other hand, a technology for realizing sub-wavelength imaging by combining a plurality of materials differing only for their permittivity has been developed. Such technology has been intensively studied as a viable structure (A. Salandrino and N. Engheta, Physical Review B, Vol. 74, 075103 (2006)). Specifically, a multilayer structure in which metallic layers and dielectric layers are alternatively stacked is one example. Sub-wavelength imaging based on similar principle can be performed by using a metal nano wire array (A. Salandrino and N. Engheta, Physical Review B, Vol. 74, 075103 (2006); M. G. Silveirinha et al., Physical Review B, Vol. 75, 035108 (2007)).

### SUMMARY OF THE INVENTION

The technology of sub-wavelength imaging utilizing metamaterial is expected to have applications in a field of optics. It is difficult to provide a thick imaging element due to its relatively large light absorption. Thickness of metal/dielectric material multilayer film actually designed or experimentally produced is at most several hundreds nano meters. On the other hand, absorption of the structure of metal nano wire array is relatively small and element having thickness of approximately 10 μm has been experimentally produced. The imaging efficiency of such element is inferior. Such problems are not occurred only in sub-wavelength imaging but in detection system for detecting ultrahigh wavenumber.

An ultrahigh-wavenumber transmitting element according to the present disclosure includes:
at least two anisotropic media having slopes of isofrequency curves complementary with each other, wherein
the at least two anisotropic media are layered so as to transmit ultrahigh wavenumber.

According to one aspect of the disclosure of the ultrahigh-wavenumber transmitting element, the at least two anisotropic media are preferably layered so as to their optic axis are directed to the same direction.

According to one aspect of the disclosure of the ultrahigh-wavenumber transmitting element, each of the anisotropic media preferably exhibits anisotropy in permittivity.

According to one aspect of the disclosure, the ultrahigh-wavenumber transmitting element preferably includes a first anisotropic medium exhibiting the isofrequency curve having a hyperbolic form and a second anisotropic medium exhibiting the isofrequency curve having an ellipsoidal form.

According to one aspect of the disclosure of the ultrahigh-wavenumber transmitting element, the second anisotropic medium exhibiting the isofrequency curve having the ellipsoidal form preferably shows lower loss than the first anisotropic medium exhibiting the isofrequency curve having the hyperbolic form.

According to one aspect of the disclosure, the ultrahigh-wavenumber transmitting element preferably satisfies

$$\vert {\sum }_{i = 1}^{N} {d}_{i} tan {θ}_{i} \vert < λ \text{/} 2$$

where N represents a number of layers formed of the anisotropic media and is an integer not less than two; each of θ₁, θ₂, . . . , and θ_{N} represents an angle between a normal of each isofrequency curve formed of an anisotropic medium and an optic axis; each of d₁, d₂, . . . , and d_{N} represents a thickness of each anisotropic medium; λ represents a wavelength of a light beam incident upon the ultrahigh-wavenumber transmitting element.

A near-field optical microscope includes:
a light irradiating part for emitting illumination light toward a sample;
a light receiving part for receiving light;
a microstructure for generating or selectively transmitting near-field light, the microstructure being disposed on at least any one of an emission side of the light irradiating part and an incident side of the light receiving part, and
an ultrahigh-wavenumber transmitting element as any of the above mentioned.

### BRIEF DESCRIPTION OF THE DRAWINGS

FIG. 1 is a perspective view showing schematic structure of an ultrahigh-wavenumber transmitting element according to a first embodiment of the present invention.

FIG. 2 is a graph showing optical characteristics of the first anisotropic medium and the second anisotropic medium forming the ultrahigh-wavenumber transmitting element of FIG. 1 as isofrequency curves.

FIG. 3A is a view illustrating a structure in which a point light source is disposed in close contact with the ultrahigh-wavenumber transmitting element of FIG. 1.

FIG. 3B is a view illustrating a structure in which a point light source is arranged with a gap with respect to the ultrahigh-wavenumber transmitting element of FIG. 1.

FIG. 4 is a graph of isofrequency curves showing the electromagnetic simulation result of the ultrahigh-wavenumber transmitting element of FIG. 1.

FIG. 5 is a graph showing an energy density distribution in an image plane as a result of electromagnetic simulation.

FIG. 6 is a graph showing a result of a simulation in which the thicknesses of the first anisotropic medium and the second anisotropic medium and the permittivity of the second anisotropic medium of the ultrahigh-wavenumber transmitting element of FIG. 1 are varied.

FIG. 7 is a graph showing an energy density distribution in an image plane as a result of electromagnetic simulation.

FIG. 8 is a diagram illustrating a result of ray trace performed for a structure in which a point light source disposed in close contact with the ultrahigh-wavenumber transmitting element of FIG. 1.

FIG. 9 is a graph showing changes in effective permittivity as a function of filling factor when an effective medium approximation against a metal dielectric material multilayer film is performed.

FIG. 10 is a schematic view illustrating an example of structure of the near-field optical microscope system having the ultrahigh-wavenumber transmitting element of FIG. 1.

### DESCRIPTION OF PREFERRED EMBODIMENTS

In the following, embodiments of an ultrahigh-wavenumber transmitting element and a near-field optical microscope using thereof according to the present invention are described in detail with reference to the accompanying drawings.

### First Embodiment

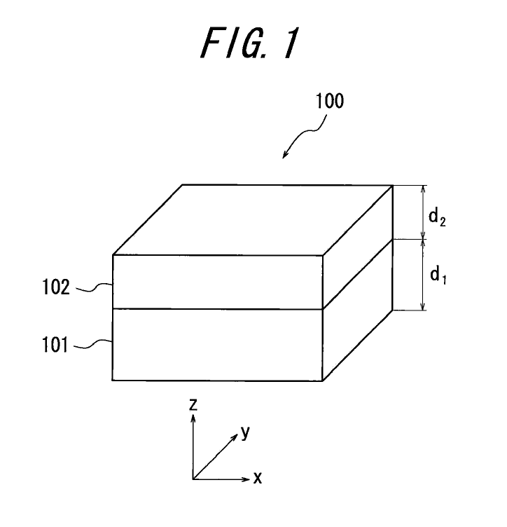

FIG. 1 is a perspective view showing schematic structure of an ultrahigh-wavenumber transmitting element according to a first embodiment of the present invention. The ultrahigh-wavenumber transmitting element 100 has the first anisotropic medium 101 with a thickness of d₁ and the second anisotropic medium 102 with a thickness of d₂. The second anisotropic medium 102 is layered on the first anisotropic medium 101. The ultrahigh-wavenumber transmitting element 100 transmits optical information in the direction of the Z-axis.

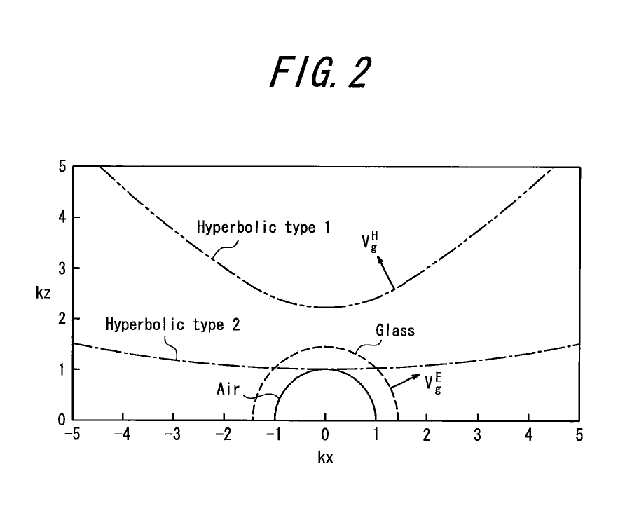

FIG. 2 is a graph showing optical characteristics of the first anisotropic medium and the second anisotropic medium forming the ultrahigh-wavenumber transmitting element of FIG. 1 as isofrequency curves. Here, the isofrequency curve shows changes in each component included in a wave vector in the case where a frequency is maintained constant. In the graph, the horizontal axis shows the X-axis direction component of the wave vector and the vertical axis shows the Z-axis direction component of the wave vector. Each permittivity of the first anisotropic medium 101 and the second anisotropic medium 102 shows anisotropy with an optic axis coinciding with the Z-axis. That is, the ultrahigh-wavenumber transmitting element 100 has the first anisotropic medium 101 and the second anisotropic medium 102 layered in a direction where their optic axis coincide with each other. As discussed in detail later, the first anisotropic medium 101 and the second anisotropic medium 102 are selected so that slopes of respective isofrequency curves are complementary with each other. In this way, the ultrahigh-wavenumber transmitting element 100 is formed of the first anisotropic medium 101 and the second anisotropic medium 102 having slopes of isofrequency curves complementary with each other. These media are layered so as to their optic axis are directed to the same direction so as to transmit ultrahigh wavenumber with a high efficiency.

A permittivity tensor ∈̂₁ of the first anisotropic medium 101 and a permittivity tensor ∈̂₂ of the second anisotropic medium 102 are given by a formula below. Here the notation “∈̂” stands for hat, “̂”, is placed above “∈”.

$${{ɛ}^{}}_{1} = ( \begin{matrix}{ɛ}_{1 T} & 0 & 0 \\ 0 & {ɛ}_{1 T } & 0 \\ 0 & 0 & {ɛ}_{1 Z}\end{matrix} ) and {{ɛ}^{}}_{2} = ( \begin{matrix}{ɛ}_{2 T} & 0 & 0 \\ 0 & {ɛ}_{2 T} & 0 \\ 0 & 0 & {ɛ}_{2 Z}\end{matrix} ) \qquad Eq . ( 1 )$$

In the above formula, ∈_{1T} and ∈_{1Z}, ∈_{2T} and ∈_{2Z} can be different values with each other. In the following, the first anisotropic medium 101 is assumed to exhibit a hyperbolic type dispersion and the second anisotropic medium 102 is assumed to exhibit an ellipsoidal type dispersion. That is, ∈_{1T} and ∈_{1Z} have opposite signs to each other and both ∈_{2T} and ∈_{2Z} have positive value. Please note that isotropic medium satisfying a condition, ∈_{2T}=∈_{2Z}, can be employed as second anisotropic medium 101, in a special case.

TM (Transverse Magnetic) waves in an anisotropic medium, that is, the transmission of electromagnetic waves with a magnetic field oscillating in the Y-axis direction are given by the following formula.

$$\frac{{k}_{nx}^{2} + {k}_{ny}^{2}}{{ɛ}_{nZ}} + \frac{{k}_{nz}^{2}}{{ɛ}_{nT}} = {μ}_{ny} \qquad Eq . ( 2 )$$

In the above formula, n stands for a variable for differentiating each medium forming the ultrahigh-wavenumber transmitting element 100. In the present embodiment, 1 or 2 is substituted into n, since the ultrahigh-wavenumber transmitting element 100 shown in FIG. 1 includes the first anisotropic medium 101 and the second anisotropic medium 102. Here, the wave vector in the n^{th} medium is shown as kₙ=(kₙₓ, k_{ny}, k_{nz}). The components of the wave vector, the permittivity tensor and the permeability tensor are normalized with the wavenumber in vacuum k₀=ω/c, permittivity in vacuum ∈₀ and permeability in vacuum μ₀ respectively. The symbol w stands for angular frequency of electromagnetic waves and c stands for light speed in vacuum. In this way, in the case where the frequency is fixed to a certain value, the trajectory of the wave vector components (isofrequency curve) corresponds to a quadratic curve. Specifically, the form of isofrequency curve of the first anisotropic medium 101 should be a hyperbolic curve and the form of isofrequency curve of the second anisotropic medium 102 should be an ellipse.

Moreover, in the case where the Eq. (1) is satisfied for a permeability μ, TE (Transverse Electric) waves can be analyzed in the same manner disclosed above. Also, as far as Eq. (1) is satisfied both for ∈ and μ, the forms of the isofrequency curves is a combination of a hyperbolic curve and an ellipsoidal curve for both polarizations.

Further, FIG. 2 shows isofrequency curves for air, glass, and a medium exhibiting two kinds of hyperbolic type dispersion (hereinafter, referred to as “hyperbolic type dispersion medium”). The glass is described as an example of a medium exhibiting ellipsoidal type dispersion (hereinafter, referred to as “ellipsoidal type dispersion medium”). The curve shown as “hyperbolic type 1” is described as an example of a medium exhibiting hyperbolic type dispersion. Conventionally, a medium has been produced by using metal materials so as to form a relatively flat isofrequency curve and the resultant energy loss occurred when the light passes through the medium has been larger.

When the ultrahigh-wavenumber transmitting element 100 is applied to a near field optical microscope described in the second embodiment of the present disclosure, and functions as an imaging element, the optical information on the sample plane (object plane) to be observed is transmitted onto the imaging plane. The optical information is transmitted to the imaging plane by waves having various kₓ values. In terms of a wave with a certain value of kₓ, this value kₓ is maintained even if the wave transmits from one medium to other medium. On the other hand, the direction of energy transmission within the media corresponds to the direction of group velocity V_{g} that corresponds to a normal of the isofrequency curve as shown in FIG. 2.

FIG. 2 illustrates an arrow shown as V_{g}^{E} as an example of a normal for a curve of glass that is an example of an ellipsoidal type dispersion medium. Also, an arrow shown as V_{g}^{H} as an example of a normal for a hyperbolic type 1 that is an example of a hyperbolic type dispersion medium. In the case where a condition, ∈_{1T}>0 and ∈_{1Z}<0, is satisfied in Eq. (1), the isofrequency curve is a hyperbolic curve. Specifically, in the case where a calculated value of the following formula is large, the isofrequency curve becomes a curve with a small curvature as the curve shown as hyperbolic type 2.

α≡|∈_{1Z}/∈_{1T}| Eq. (4)

In this case, directions of its group velocities are maintained approximately constant regardless of their kₓ values, and optical information is transmitted from the object plane to the imaging plane without substantial change so as to realize a sub-wavelength imaging of high precision. However, in the case where the hyperbolic type dispersion is realized by using metal/dielectric materials multilayer film or metal nano-wire array, it is difficult to obtain a large value of α and the isofrequency curve inevitably becomes a form similar to the hyperbolic type 1. In this case, several waves corresponding to different kₓ values are transmitted to different areas on the imaging plane and the resultant imaging quality is deteriorated.

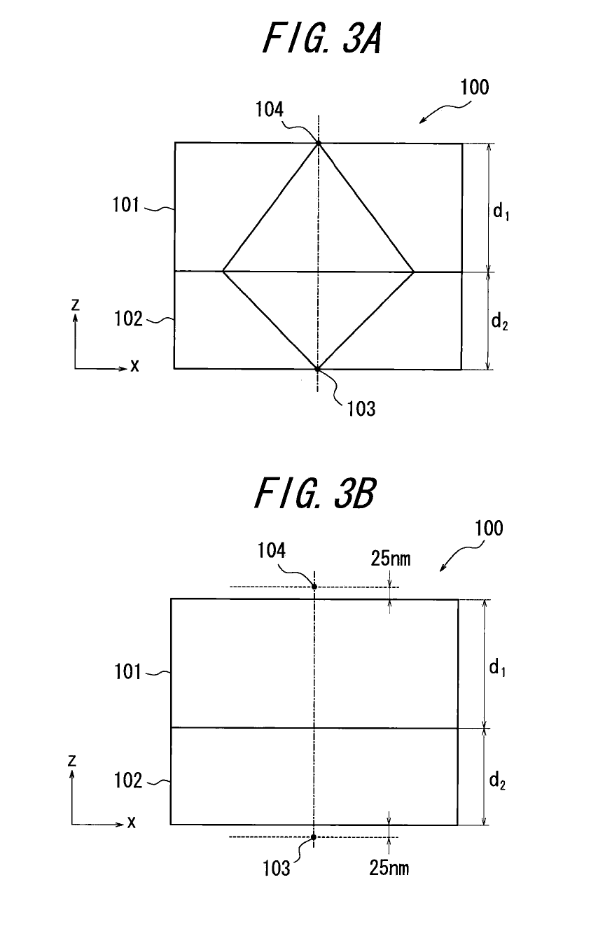

Here, a structure formed of the first anisotropic medium 101 (hyperbolic type dispersion medium) and the second anisotropic medium 102 (ellipsoidal type dispersion medium) layered each other, as shown in FIG. 3A and FIG. 3B, is described in detail as one example of the present disclosure. FIG. 3A is a view illustrating a structure in which a point light source 103 is disposed in close contact with the ultrahigh-wavenumber transmitting element 100 and FIG. 3B is a view illustrating a structure in which a point light source 103 is arranged with a gap with respect to the ultrahigh-wavenumber transmitting element 100. The point light source 103 is disposed in close contact with the second anisotropic medium 102 in FIG. 3A. The light emitted from the point light source 103 is transmitted in a different direction in the first anisotropic medium 101 that exhibits the hyperbolic type dispersion and the second anisotropic medium 101 that exhibits the ellipsoidal type dispersion as shown in FIG. 2. Accordingly, light flux can be concentrated on the image plane as a point image 104 by optimizing permittivity tensor and thickness of each the first anisotropic medium 101 and the second anisotropic medium 102, respectively. The point light source 103 may be an electric dipole element and may generate an evanescent field.

As shown in FIG. 3B, in the case where the point light source 103 is arranged with a gap with respect to the second anisotropic medium 102, the light flux can be concentrated on the image plane as a point image 104 by optimizing permittivity tensor and thickness of each anisotropic medium. In this case, the gap between the second anisotropic medium 102 and the point light source 103 may be 25 nm, for example, and the gap is determined as a distance as short as the evanescent field generated from the point light source 103 made of electric dipole element and so on is not attenuated.

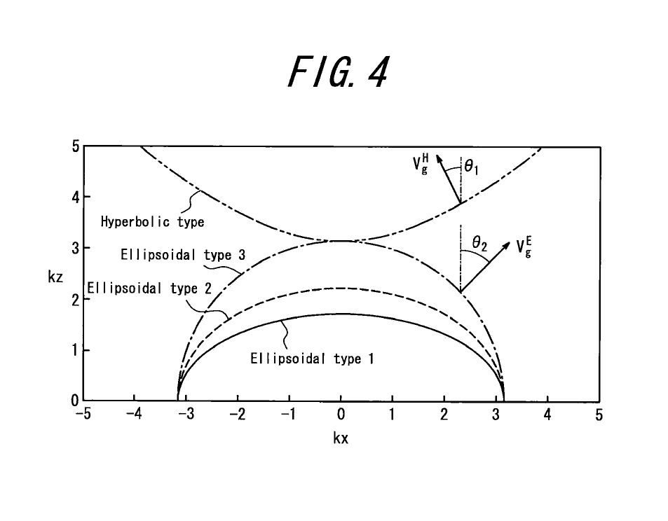

In the followings, electromagnetic field simulation result based on finite element method by referring to FIG. 3B and FIG. 4. A structure shown in FIG. 3B was employed as an analysis model and the thickness d₁ of the first anisotropic medium 101 and the thickness d₂ of the second anisotropic medium 102 were varied under a restriction, d₁+d₂=1,000 nm. Permittivity of each medium was determined to satisfy the following formula.

∈_{1T}=∈_{2T}=∈_{2Z}=10+i, ∈_{1Z}=−10+i Eq. (3)

Isofrequency curves corresponding to the above values were the curves shown as hyperbolic type and the ellipsoidal type 3 in FIG. 4. An electric dipole element oscillating in a direction of the X axis was used as the point light source (point light source object) 103 and frequency was adjusted to 600 THz (corresponding to wavelength of 500 nm in vacuum). Each of the gaps between the light source 103 and the first anisotropic medium 101 and between the second anisotropic medium 102 and the image plane, where the point image 104 was formed, was 25 nm, respectively.

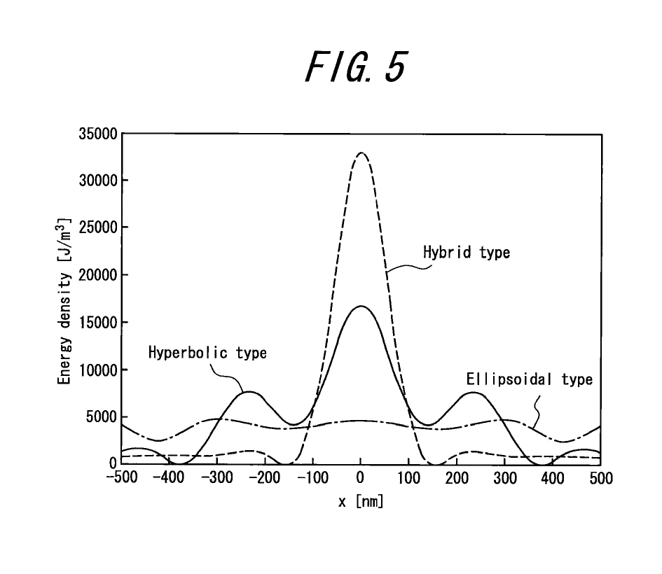

FIG. 5 is a graph showing an energy density distribution in the image plane. Thickness of each medium were determined as d₁=1,000 nm and d₂=0 nm for the hyperbolic type, d₁=700 nm and d₂=300 nm for a hybrid type, and d₁=0 nm and d₂=1,000 nm for the ellipsoidal type. Better single peak was obtained for the hybrid type compared to the hyperbolic type and the ellipsoidal type. Full width at half maximum (FWHM) at a peak in the center (x=0 nm) was calculated for estimating a quality of the point image quantitatively. The resultant values of FWHM were 169 nm for the hyperbolic type and 131 nm for the hybrid type.

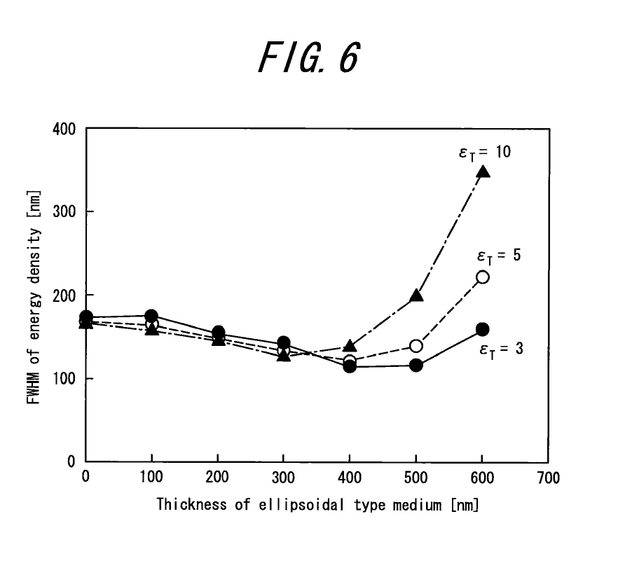

Further, FIG. 6 shows a result of a simulation in which the thicknesses of the first anisotropic medium 101 and the second anisotropic medium 102 and the permittivity of the second anisotropic medium 102 are varied. The vertical axis shows FWHM of the changes of energy density in the image plane shown in FIG. 5 and the horizontal axis shows thicknesses of the media exhibiting the ellipsoidal type dispersion. The permittivity of the second anisotropic medium 102 was fixed to ∈_{Z}=10 and ∈_{T} was varied as ∈_{T}=3, 5, 10. The isofrequency curves corresponding to these values were ellipsoidal type 1, 2, and 3 in FIG. 4. The slope θ representing the tilting angle of the arrows showing group velocity became larger as the value of ∈_{T} grew. Accordingly, the thickness of ellipsoidal type medium necessary for compensating an effect generated by the hyperbolic type medium became thinner. This relation is apparent from the result shown in FIG. 6 and larger value of ∈_{T} makes the thickness of the ellipsoidal type dispersion medium that gives the minimum FWHM thinner. Regardless of the value of ∈_{T}, the quality of the point image for a hybrid medium was better than the medium made of either of hyperbolic type medium and the ellipsoidal type medium. For example, in the case where ∈_{T}=3, a structure employing 400 nm or 500 nm of ellipsoidal type dispersion medium gave a minimum FWHM, 118 nm.

By applying the ultrahigh-wavenumber transmitting element 100 of the present embodiment to the near-field optical microscope as in the second embodiment, the imaging quality of the near-field optical microscope can be improved (smaller point image 104 can be obtained), as described above with respect to ray tracing along the direction of energy transmission. In order to demonstrate that such causal association is correct, number of layers forming multilayer structure of the ultrahigh-wavenumber transmitting element 100 was varied and subjected to an electromagnetic simulation in the same manner. As shown in FIG. 5 and FIG. 6, in the case where the permittivity of the second anisotropic medium 102 satisfies a condition, ∈_{2T}=∈_{2Z}=10+i, a structure gave the minimum FWHM (131 nm) included 700 nm of the first anisotropic medium 101 and 300 nm of second anisotropic medium 101. Under such restriction, the number of layers forming the ultrahigh-wavenumber transmitting element 100 is varied and subjected to an electromagnetic field simulation in the same fashion.

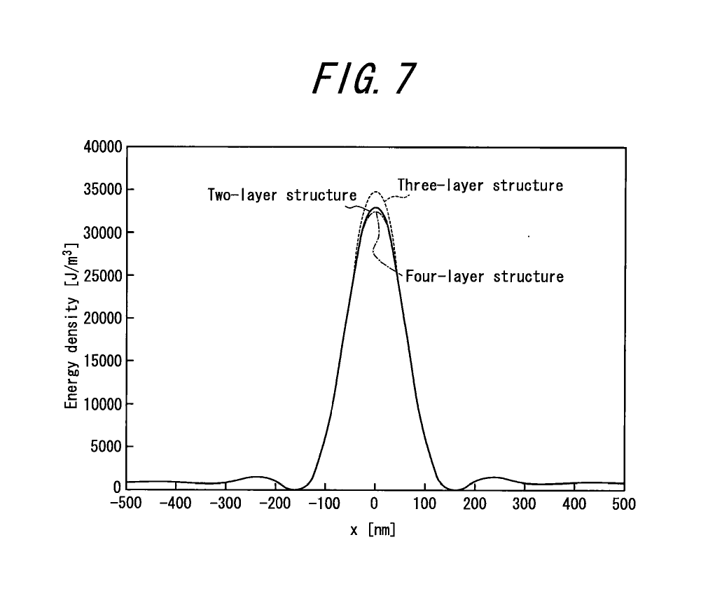

In such electromagnetic field simulation, thickness of each layer is determined as follows. A thickness of a layer disposed closer to the point light source 103 is described in the left.
Two-layer structure: hyperbolic type 700 nm, ellipsoidal type 300 nm
Three-layer structure: hyperbolic type 350 nm, ellipsoidal type 300, hyperbolic type 350 nm
Four-layer structure: hyperbolic type 350 nm, ellipsoidal type 150 nm, hyperbolic type 350 nm, ellipsoidal type 150 nm
   FIG. 7 shows an energy density distribution in an image plane when the above structures were excited by the electric dipole element (point light source 103). Regardless of the number of layers, substantially same dispersion was obtained and this result demonstrated that the media of hyperbolic type dispersion and ellipsoidal type dispersion functioned for compensating each other as described in the viewpoint of ray tracing (based on the energy transmission).

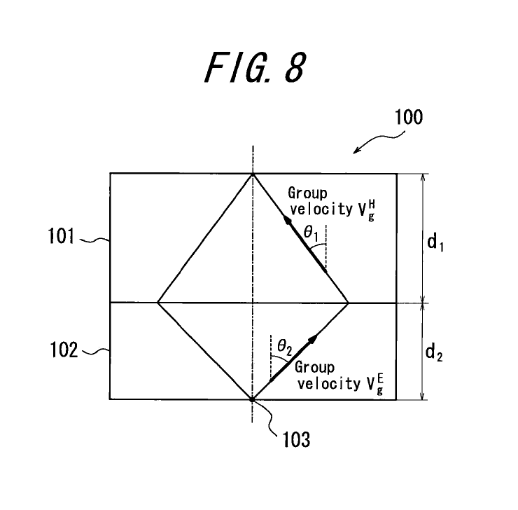

Here, in order to clarify the function of the ultrahigh-wavenumber transmitting element 100 of the present embodiment, a ray tracing diagram in the ultrahigh-wavenumber transmitting element 100 will be described with referring to FIG. 8. FIG. 8 is a ray tracing diagram for a structure in which a point light source 103 disposed in close contact with the first anisotropic medium 101. Two light beams symmetric with respect to the optic axis are illustrated among a number of light beams emitted from the point light source 103. The direction to which a predetermined light beam emitted from the point light source 103 transmits can be figured out based on the isofrequency curves in FIG. 4. In a medium exhibiting dispertion relation according to the ellipsoidal type 3, for example, a light beam (light wave) with a certain value of kₓ transmits along the direction of the group velocity given by the arrow V_{g}^{e} shown in FIG. 4 (equals to the direction of a normal of the isofrequency curve). When a light transmitting through the ellipsoidal type dispersion medium enters a hyperbolic type dispersion medium, the value of kₓ is stable, due to wave-front continuity. Thus, the value of k_{z} and the direction of group velocity in the hyperbolic type dispersion medium can be obtained in the same manner as the method applied for the ellipsoidal type dispersion medium. As shown in FIG. 8, given that a thickness of the first medium exhibiting hyperbolic dispersion is determined as d₁, a slope of a group velocity is determined as θ₁, a thickness of the second medium exhibiting ellipsoidal type dispersion is determined as d₂, and a slope of a group velocity is determined as θ₂, two light beams come to intersect the optical axis of the near-field optical microscope having the ultrahigh-wavenumber transmitting element 100 as shown in the second embodiment of the present invention at the upper surface of the hyperbolic dispersion medium, when Eq. (4) is satisfied.

d₁ tan θ₁+d₂ tan θ₂=0 Eq. (4)

Here, Eq. (4) can be generalized for the ultrahigh-wavenumber transmitting element formed of N layers of anisotropic media. Given that the angles between respective normal for isofrequency curves and an optic axis are determined as θ₁, θ₂, . . . , and θ_{N}, and thicknesses of the respective anisotropic media are determined as d₁, d₂, . . . , and d_{N}, wave vectors satisfying Eq. (5) transmits optical information via the ultrahigh-wavenumber transmitting element.

$${\sum }_{i = 1}^{N} {d}_{i} tan {θ}_{i} = 0 \qquad Eq . ( 5 )$$

In this case, an ideal point image is formed at the upper surface (image plane) of the hyperbolic type dispersion medium. Here, the respective slopes θ of the group velocities are defined regarding their signs. For example, in the example of FIG. 8, conditions, θ₁<0 and θ₂>0, are satisfied. In the above discussion, an imaging performed by using one point light source has been described for convenience of illustration. However, in the case where a plurality of point light sources is distributed on a lower surface (object plane) of the ellipsoidal type dispersion medium, similar relation is found for each point light source. In other words, two-dimensional optical information related to the object surface can be transmitted to the image plane with a high degree of accuracy, when Eq. (5) is satisfied.

The above discussion has been made for an imaging using the point light source 103. However, the actual light source naturally has a finite size and light beam also has a finite width. Accordingly, even in the case where the plurality of light beams emitted from the light sources is corrected at one point on the image plane, an obtained resolution becomes finite value (as much as the width of each light beam), since the light beams has their own widths. In other words, given that a resolution of imaging system is δ, the imaging quality may be discussed based on a degree of aggregation of light beams having widths as long as δ. In designing an optical system in a microscope and an optical recording system, if the ray aberration became as small as wavelength, aberration correction can not improves imaging quality any more, and the resultant resolution and spot size may be determined by the diffraction limit. Similarly, a design target regarding how close the imaging position of the light beam having width of δ is situated may be determined by regarding δ as a goal. Accordingly, in an actual optical system design, Eq. (6) needs to be satisfied.

|d₁ tan θ₁+d₂ tan θ₂<δ Eq. (6)

In an imaging element used for sub-wavelength imaging, generally, δ is smaller than a wavelength λ. In a conventional high-spec optical microscope, a value of δ is not less than λ/2 and it has been difficult to realize higher resolution.

The greater left-hand side value of Eq. (6) deteriorates imaging quality to a greater extent and the resolution is approximately similar to the left-hand side value. Accordingly, the following formula, Eg. (7), needs to be satisfied for at least one wave vector for obtaining the better resolution than the conventional optical microscope (having resolution of at most λ/2 due to its diffraction limit).

$$\vert {\sum }_{i = 1}^{N} {d}_{i} tan {θ}_{i} \vert < λ \text{/} 2 \qquad Eq . ( 7 )$$

N represents a number of layers formed of the anisotropic media and is an integer not less than two. Each of θ₁, θ₂, . . . , and θ_{N} represents an angle between a normal of each isofrequency curve formed of an anisotropic medium and the optic axis. Each of d₁, d₂, . . . , and d_{N} represents a thickness of each anisotropic medium. A symbol λ represents a wavelength of a light beam incident upon the ultrahigh-wavenumber transmitting element. The Eq. (7) is satisfied for wave vectors within a certain range.

As shown in FIG. 4, slopes of the hyperbolic isofrequency curve and the ellipsoidal type isofrequency curves for an arbitrary kₓ within a determined range are different each other so as to compensate a side shift amount of the light beam included by transmission mutually. Such relationship may be described by a term, “complementary”, in the present disclosure. That is, the hyperbolic type dispersion medium and the ellipsoidal type dispersion medium can be regarded as a pair of complementary mediums. There is no need for conforming both absolute values of the slopes of the group velocities and the thicknesses d₁ and d₂ can be determined so as to satisfy the Eq. (6) for each group velocity (θ₁ or θ₂) in the respective media. Similarly, in the case where the anisotropic medium is formed of more than three layers, the thickness dᵢ can be determined for satisfying the Eq. (7) for each slope θᵢ of group velocity in the respective anisotropic media forming each layer. As shown in FIG. 4, when the forms of the isofrequency curves of neighboring anisotropic media are different, Eq. (6) and Eq. (7) are satisfied only in a determined range of kₓ. It is desirable the Eq. (6) and Eq. (7) are satisfied in a broader range. However, even if the range is not very broad, good imaging quality can be obtained under a condition where a spatial frequency included in the optical information on the object plane is substantially included in the range.

In the present embodiment, the optic axis of respective anisotropic media forming layers are assumed to be in line completely, this is one aspect of a case in which anisotropic layers are layered so as to direct their optic axis in the same direction. Here, such arrangement where anisotropic layers are layered so as to direct their optic axis in the same direction means an arrangement where the optic axis of respective anisotropic media are in line to a certain extent where the Eq. (7) is satisfied if not the optic axis of the respective anisotropic media are completely in line, and not limited to an arrangement where the optic axis are exactly conformed. In a preferable case, optic axis of the respective anisotropic media are arranged in the same direction and in this case, the curves are symmetric with respect to an axis kₓ=0, corresponding to an optic axis, for positive and negative values, traveling directions of a light beam transmission for positive and negative wave vectors are also symmetric, as shown in FIG. 4. Accordingly, design and control for a layered anisotropic media for transmitting ultrahigh wavenumbers having higher frequencies are facilitated.

It is desirable for wave vectors satisfying Eq. (7) are within the range, |kₓ|≧1, since the ultrahigh-wavenumber transmitting element described in the present embodiment is designed specifically for transmitting finer optical information relative to a wavelength of a used light beam. The fact that the isofrequency curves are even functions of the kₓ means that the Eq. (7) is satisfied for at least two kₓ values. Moreover, as shown in FIG. 4, Eq. (7) is satisfied in vicinity of kₓ=0, since the condition, θ₁≈θ₂≈0, is satisfied around kₓ=0. In such a case where the Eq. (7) is satisfied for three kₓ values differing by not less than one with respect to one another, the (hyperbolic or ellipsoidal) forms of the isofrequency curves are smooth. This means that the left hand side values of Eq. (7) are small in a relatively wide range of kₓ values and good imaging quality can be obtained. Moreover, the wider ranges of kₓ values satisfy Eq. (7), the better imaging quality can be obtained.

As mentioned above, the anisotropic media such as a hyperbolic type dispersion medium and an ellipsoidal type dispersion medium can be formed by a metal-dielectric multilayer or a metallic nano wire array. Specific examples will be described in the followings. As demonstrated in prior arts, effective permittivity according to effective medium approximation to metal dielectric material multilayer film is given by the following formula (A. Salandrino and N. Engheta, Physical Review B, Vol. 74, 075103, 2006; M. G. Silveirinha et al., Physical Review B, Vol. 75, 035108, 2007).

∈_{T}=f∈_{M}+(1−f)∈_{D}

∈_{Z}={f∈_{M}⁻¹+(1−f)∈_{D}⁻¹}⁻¹ Eq. (8)

Here, ∈_{M} represents a permittivity of a metal; ∈_{D} represents a permittivity of a dielectric material; f represents a metal filling factor, that is, a volume ratio of metal to a whole volume the medium.

As one example of above mentioned metal dielectric material multilayer film, multilayer system including Ag and Al₂O₃ is described below. A permittivity at 365 nm wavelength is as follows.

∈_{M}=−2.4+0.249i, ∈_{D}=3.22

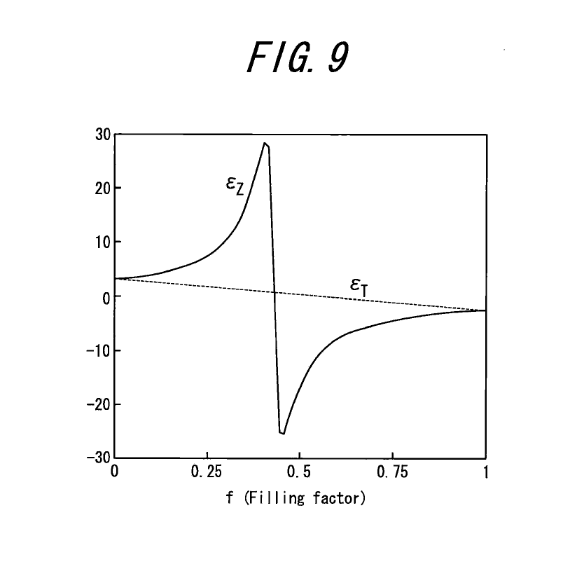

These values are substituted to the Eq. (8) to obtain real parts of ∈_{T} and ∈_{Z}. The obtained values are shown as functions of f in FIG. 9. In the range satisfying a condition, 0<f<0.43, conditions, ∈_{T}>0 and ∈_{Z}>0, are satisfied and the medium behaves as an ellipsoidal type dispersion medium. In the range satisfying a condition, 0.43<f<0.57, conditions, ∈_{T}>0 and ∈_{Z}<0, are satisfied and the medium behaves as a hyperbolic type dispersion medium. In this way, a form of an isofrequency curve can be varied drastically by varying its filling factor under a defined material and operating frequency (wavelength). Moreover, by varying the material and operating frequency, wider variety of effective media can be generated. The effective medium approximation to metallic nano wire array is also described in many prior art documents (M. G. Silveirinha et al., Physical Review B, Vol. 75, 035108, 2007).

In the present embodiment, a material exhibiting anisotropy is used. However, in the light of the degree of anisotropy, an anisotropic medium exhibiting hyperbolic type dispersion is deemed to be more peculiar than that exhibiting ellipsoidal type dispersion. For example, in the case where multilayer or wire array structure is formed by using dielectric materials with different permittivities, values of ∈_{T} and ∈_{Z} are positive in most cases and the structure exhibits an ellipsoidal type dispersion and never exhibits a hyperbolic type dispersion. Metals show negative permittivity in a certain wavelength. Only when a defined anisotropic structure is formed by using metal exhibiting negative permittivity within a defined range of wavelength where imaging is performed, a hyperbolic type dispersion, where either ∈_{T} or ∈_{Z} is negative, can be attained. As to multilayer film structure, Eq. (8) may be used in an explanation. In the case where both ∈_{M} and ∈_{D} are positive values, both ∈_{T} and ∈_{Z} are nothing except for positive values for filling factor f, not less than zero and not more than 1. As to the wire array structure, similar description can be made based on formulas in the prior art document in the same manner (M. G. Silveirinha et al., Physical Review B, Vol. 75, 035108, 2007).

Because of above mentioned reasons, ellipsoidal type dispersion can be obtained in a relatively easier manner and ellipsoidal type dispersions are obtained with respect to a relatively broader range of filling factors. Further, referring to FIG. 9, a region exhibiting ellipsoidal type dispersion includes smaller values of filling factors than a region exhibiting hyperbolic type dispersion. This means a ratio of metal is small in the region exhibiting ellipsoidal type dispersion and an energy loss is low. In the present embodiment, the ellipsoidal type dispersion can be attained by using only two kinds of transparent dielectric materials and in this case, substantially lossless structure is realized. Accordingly, such structure where a structure with an improved imaging quality is formed by a combination of lossless or low-loss ellipsoidal type dispersions is more preferable in the light of the energy loss than the hyperbolic type dispersion that requires metal and can not avoid the energy loss. Referring to FIG. 5, an example showing an improved imaging quality in a mixed-type medium, compared to a hyperbolic type medium. Regarding FIG. 5, the simulation was performed based on an assumption that every media contained the same amount of losses. However, in an actual design of medium, ellipsoidal type dispersion medium can be designed as a medium with lower loss relative to a hyperbolic type dispersion medium.

In this way, according to the ultrahigh-wavenumber transmitting element 100 of the present embodiment, the energy loss is reduced as a whole and efficient transmission can be realized, since the hyperbolic type dispersion medium and the ellipsoidal type dispersion medium including lower losses of light energy and so on are layered so as to their optic axis are directed to the same direction. Accordingly, when applied for an imaging element, a thick optical element with an excellent imaging quality is produced. By forming the ultrahigh-wavenumber transmitting element in a thickness thicker than a certain thickness, efficient production is realized and durability as an optical element is improved, when it is employed in a near-field optical microscope mentioned below.

### Second Embodiment

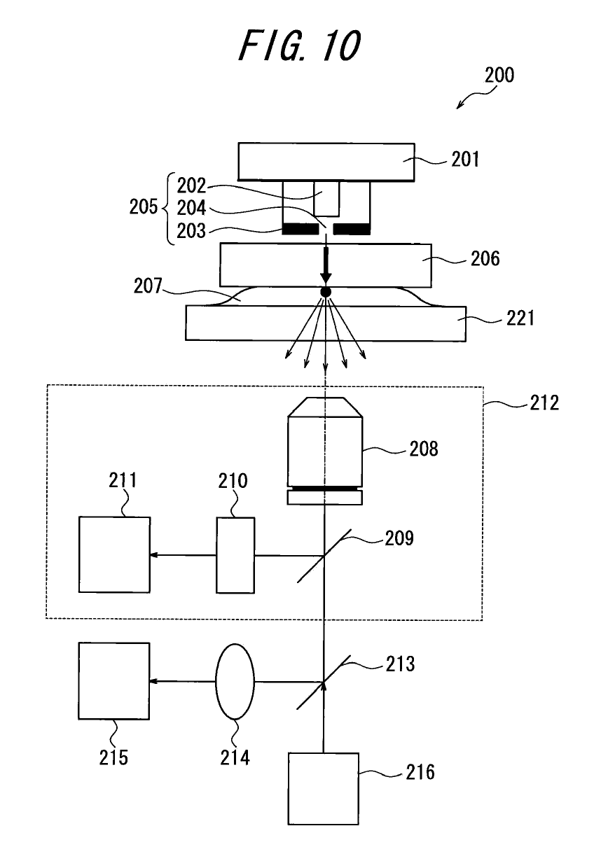

FIG. 10 illustrates a system configuration of a near-field optical microscope comprising the above mentioned ultrahigh-wavenumber transmitting element. The near-field optical microscope 200 includes a scanning part 201, a near-field light source 205, an ultrahigh-wavenumber transmitting element 206, a light receiving part 212, a half mirror 213, an imaging lens 214, an imaging element 215, and an optical microscope illuminating part (hereinafter, referred to as OM illuminating part) 216. The ultrahigh-wavenumber transmitting element 206 is disposed between a sample 207 and an aperture 204. The light receiving part 212 includes an objective 208, a dichroic mirror 209, a filter 210, and a light receiving element 211.

A light shielding member 203 is irradiated with light (with a wavelength Eλ) emitted from a light source 202 forming a light irradiating part for emitting illumination light toward the sample 207. The light shielding member 203 has the aperture 204 smaller than the wavelength of light, and hence the light that has passed through the aperture 204 leaks out, as near-field light, to the rear side of the light shielding member 203. In other words, the aperture 204 formed of a microstructure is disposed on an emission side of the light source 202 forming the light irradiating part, and generates near-field light. Hereinafter, the near-field light is referred to as illumination light. In the downstream of the light shielding member 203, the ultrahigh-wavenumber transmitting element 206 is disposed at spacing smaller than the wavelength, and the illumination light in part enters the ultrahigh-wavenumber transmitting element 206.

The ultrahigh-wavenumber transmitting element 206 exhibits anisotropy in permittivity or permeability, and is configured to transmit near-field light. Optical performance of the ultrahigh-wavenumber transmitting medium is described later. The ultrahigh-wavenumber transmitting element 206 is capable of transmitting illumination light over a long distance as propagating light, which otherwise becomes near-field light in air, with the result that part of light emitted from the light source 202 can be brought to the sample 207 in the end. In other words, the ultrahigh-wavenumber transmitting element 206 transmits near-field light generated at the aperture 204 forming a microstructure and emits the light as illumination light toward the sample 207.

Here, the sample 207 is configured to have fluorescent dye diffused therein, which generates fluorescence having a wavelength Fλ when excited by light having a wavelength Eλ. The fluorescent dye in the sample 207 is excited by light irradiated from the light source 202 via the aperture 204 and the ultrahigh-wavenumber transmitting medium. The fluorescent dye may be directly diffused in the sample 207, or may be processed to the form of fluorescent beads so as to be contained in the sample 207. Alternatively, fluorescent proteins such as green fluorescent proteins (GFP) may be coupled to the sample 207, so that a specific site or function of the sample 207 can be observed. The fluorescence with a wavelength Fλ generated by the fluorescent dye passes in part through the objective 208 to be reflected by the dichroic mirror 209, and enters the filter 210.

In general, fluorescence to be generated by using fluorescent dye or Quantum dot is very weak in fluorescent intensity with respect to excitation light. For this reason, in the system configuration shown in FIG. 10, excitation light that is higher in intensity than fluorescence is also caused to enter the objective 208, besides fluorescence. However, the filter 210 is designed to filter out excitation light while allowing fluorescence to pass therethrough, and hence only the fluorescence is detected by the light receiving element 211. Light including information (signal) on the sample 207, such as the above-mentioned fluorescence, excitation light, or transmitted light that has passed through the sample, is hereinafter referred to as signal light. The light receiving part 212 is configured to receive light (signal light) from the sample 207.

Illumination light that has been carried to the sample 207 through the ultrahigh-wavenumber transmitting element 206 forms near-field light in air or in the sample, and hence spreads only in the vicinity of the incident point on the sample 207 without traveling any further. In other words, even if the sample has fluorescent dye uniformly dispersed therein, only the fluorescent dye in the immediate vicinity of the incident point of the near-field light is excited. As a result, the light receiving part 212 can exclusively detect local information (spatial distribution of the fluorescent dye in this case) on a region smaller than the wavelength of the illumination light. Accordingly, the above-mentioned process of signal light detection may be continued for a predetermined time period, so that changes over time of a phenomenon occurring in a micro region on the surface layer of the sample can be investigated.

In particular, while there is no precedent means for performing the above-mentioned local observation with respect to a sample such as a living cell, which is less rigid and unstable in shape, the use of the near-field optical microscope 200 according to the invention enables such observation. Further, signal light radiated from the sample 207 corresponds to the fluorescence generated by the fluorescent dye in the sample after being excited by reflected light, scattered light, diffracted light, or the illumination light from the sample 207, and hence the response light bears information on optical properties such as a reflectance distribution, a light-scattering coefficient distribution, and a diffraction efficiency distribution in the sample 207, or biochemical information such as a spatial distribution of the fluorescent dye in the sample 207. In the following, the information on the optical properties and the biochemical information are collectively referred to as “optical information”.

Next, again with reference to FIG. 10, description is given of a method of obtaining a two-dimensional image of a surface of the sample 207. The light source 202, the light shielding member 203, and the aperture 204 provided to the light shielding member 203 may be configured as a single unit, which is hereinafter referred to as near-field light source 205. The near-field light source 205 constitutes a light irradiating part for emitting illumination light to the sample. The aperture 204 is formed of a microstructure generating near-field light. The scanning part 201 is formed of an electric-powered stage using, for example, a motor-driven micro electro mechanical systems (MEMS) scanner or a piezo element, and capable of changing the position of the near-field light source 205 continuously along the surface of the ultrahigh-wavenumber transmitting element 206.

At this time, the surface of the sample is irradiated with the illumination light at different positions. Accordingly, the temporal change in the signal light detected by the light receiving element 211 can be associated with each position on the surface of the sample 207, to thereby obtain the fluorescent dye distribution on the surface of the sample 207. During the operation of the near-field optical microscope according to this embodiment, the scanning part 201 maintains a distance between the aperture 204 forming a microstructure and the ultrahigh-wavenumber transmitting element 206 so as to be smaller than the wavelength of illumination light. In this manner, the resolutions at the plurality of the respective observation points are made uniform, and also the receiving part 212 is allowed to detect optical information with accuracy.

In the case where the light source 202 and the aperture 204 are configured separately from each other, both the light source 202 and the aperture 204 may be moved together. However, it is also possible to move only the aperture 204. The reason is as follows. Light emitted from the light source 202 and irradiated on the aperture 204 is subjected to restriction under the diffraction limit, and hence the light has spread at least across a region that is as large as the wavelength thereof. Accordingly, even if the aperture 204 is slightly moved within the large region, there is little change in intensity of near-field light (illumination light) leaking out through the aperture 204.

The operation of the near-field optical microscope 200 has been described above by taking fluorescent observation as an example. However, the near-field optical microscope 200 is expected to function similarly so as to perform any other optical process. For example, in a case where the sample 207 has surface irregularities, or a case where the sample 207 has fluctuations in density or composition thereof, the illumination light is scattered across the surface of the sample 207. If the scattering thus caused is a scattering such as Raman scattering, that is accompanied by a change in optical frequency, the illumination light and the scattering light can be separated from each other through the filter 210 as in the case of fluorescence described above. On the other hand, if the scattering is an elastic scattering such as Rayleigh scattering and Mie scattering, the above-mentioned effect of the filter 210 cannot be expected. However, as compared to fluorescence and Raman scattering, elastically scattered light is very high in intensity, and hence illumination light to be detected together with signal light can be treated as noise light of an acceptable level.

On the other hand, irradiation light emitted from the OM illuminating part 216 passes through the half mirror 213 and the dichroic mirror 209 to be irradiated onto the observation region on the sample 207 through the objective 208. Then, light that has acted on the sample 207 is emitted from the sample 207. Part of this light again enters the objective 208, and light of a specific wavelength is reflected by the dichroic mirror 209 so as to be received by the light receiving element 211 after passing through the filter 210. Light that has passed through the dichroic mirror 209 is reflected by the half mirror 213, and imaged onto the imaging element 215 through the imaging lens 214. Although not shown, an output of the imaging element 215 is subjected to image processing in an image processing circuit (not shown), and supplied to, for example, a monitor. In this manner, the state of the sample 207 can be observed in real time. Such an optical observation method as described above is performed similarly to a conventional optical microscope with epi-illumination. In such a case where the sample 207 is transparent, illuminating means for trans-illuminating the sample 207 can be disposed on a side opposite to the optical microscope across the sample 207.

In this way, the near-field optical microscope of the present embodiment, light spot much smaller than the light wavelength can be transmitted to a distance of several micro meters or more by using the near-field optical microscope 200. Accordingly, the near-field optical microscope of the present embodiment can offer an observation of a sample in higher resolution than the conventional near-field optical microscope. In the structure shown in FIG. 10, the aperture 204 formed of the microstructure is disposed between the sample 207 and the light source 202. In other words, the aperture 204 is disposed on an emission side of the light source 202. However, the aperture 204 can also be disposed between the sample 207 and the light receiving part 212. In other words, the aperture 204 can also be disposed on an incident side of the light receiving part 212.

The present invention is in no way limited only to the above-mentioned embodiments, and various modification and alteration can be made thereto. In the first embodiment, the ultrahigh-wavenumber transmitting element formed of layered two anisotropic media is described by referring to the Figures. However, for example, the ultrahigh-wavenumber transmitting element can be produced so as to have anisotropic media formed of three layers or more, as demonstrated in the electromagnetic simulation result in FIG. 7.

In the second embodiment, the ultrahigh-wavenumber transmitting element of the present embodiment is described as one component provided in a near-field optical microscope. However, an application of the ultrahigh-wavenumber transmitting element of the present disclosure is not limited to near-field optical microscopes and the ultrahigh-wavenumber transmitting element can be applied to a variety of detection devices requiring high resolution observations.

In the first embodiment, possibility of attaining high resolution for the TM wave has been described. Referring to the Eq. (1), the condition for ∈ can be applied to μ so as to demonstrating the possibility of attaining high resolution for the TE wave. Moreover, in the case where the condition shown in the Eq. (1) is applicable to both ∈ and μ, high resolution can be attained for both TM and TE components.

1. An ultrahigh-wavenumber transmitting element, comprising
at least two anisotropic media having slopes of isofrequency curves complementary with each other, wherein
the at least two anisotropic media are layered so as to transmit ultrahigh wavenumber.

2. An ultrahigh-wavenumber transmitting element according to claim 1, wherein the at least two anisotropic media are layered so as to their optic axis are directed to the same direction.

3. An ultrahigh-wavenumber transmitting element according to claim 1, wherein each of the anisotropic media exhibits anisotropy in permittivity.

4. An ultrahigh-wavenumber transmitting element according to claim 1, comprising a first anisotropic medium exhibiting the isofrequency curve having a hyperbolic form and a second anisotropic medium exhibiting the isofrequency curve having an ellipsoidal form.

5. An ultrahigh-wavenumber transmitting element according to claim 4, wherein the second anisotropic medium exhibiting the isofrequency curve having the ellipsoidal form shows lower loss than the first anisotropic medium exhibiting the isofrequency curve having the hyperbolic form.

6. An ultrahigh-wavenumber transmitting element according to claim 1, satisfying:
$$\vert {\sum }_{i = 1}^{N} {d}_{i} tan {θ}_{i} \vert < λ \text{/} 2$$
where N represents a number of layers formed of the anisotropic media and is an integer not less than two; each of θ₁, θ₂, . . . , and θ_{N} represents an angle between a normal of each isofrequency curve formed of an anisotropic medium and an optic axis; each of d₁, d₂, . . . , and d_{N} represents a thickness of each anisotropic medium; λ represents a wavelength of a light beam incident upon the ultrahigh-wavenumber transmitting element.

7. A near-field optical microscope, comprising:
a light irradiating part for emitting illumination light toward a sample;
a light receiving part for receiving light;
a microstructure for generating or selectively transmitting near-field light, the microstructure being disposed on at least any one of an emission side of the light irradiating part and an incident side of the light receiving part, and
an ultrahigh-wavenumber transmitting element according to claim 1.
